(19) United States
(12) Patent Application Publication
(10) Pub. No.: US 2008/0273484 A1
(43) Pub. Date: Nov. 6, 2008

(54) Wireless Communication System

(75) Inventors: Hirotaka Fukutsuka, Kanagawa-ken (JP); Hiroshi Kondo, Kanagawa-ken (JP); Shinichi Ogo, Kanagawa-ken (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 10/597,281

(22) PCT Filed: Jan. 20, 2005
(86) PCT No.: PCT/JP2005/000689

§ 371 Date: Jul. 19, 2006

(30) Foreign Application Priority Data
Jan. 21, 2004 (JP) 2004-013286

(51) Int. Cl. H04Q 7/00

(52) U.S. Cl. 370/328

(57) ABSTRACT

It is an object of the present invention to provide a wireless communication system, which ensures that communication can be maintained in an excellent status although a mobile wireless station may be moved in a service area. A CPU (210) of a mobile wireless station (2) in process of transmission is operated to causes a receiving circuit (202) to periodically notify the CPU (210) of the electric field intensity of a received radio wave. When the electric field intensity of the received radio wave becomes lower than a predetermined value, the CPU (210) is operated to judge the distance from a base station (1), with which the mobile wireless station (2) is currently communicating, is increased, and the CPU (210) is operated to control the receiving circuit (202) to receive radio waves on transmission frequencies of base stations (1) other than the base station (1) and detect the electric field intensities of the received radio waves. Then, the CPU (210) is operated to control the receiving circuit (202) to receive the radio wave of the base station (1) which is the strongest in the electric field intensity of the radio wave among the base stations (1). When the data of a DTMF signal of the radio wave is indicative of “transmission permitted”, the CPU (210) is operated to control the receiving circuit (202) to switch to the base station (1) for communication. When, on the other hand, the data of the DTMF signal of the radio wave is indicative of “transmission inhibited”, the CPU (210) is operated to control the receiving circuit (202) to receive radio waves of the base stations in order of decreasing electric field intensity of the radio wave, and switch to the base station (1) which transmits DTMF signal having data indicative of “transmission permitted”.

### TECHNICAL FIELD OF THE INVENTION

The present invention relates to a wireless communication system comprising a base station and mobile wireless station, and more particularly to a wireless communication system including a plurality of base stations with an enlarged service area.

### DESCRIPTION OF THE RELATED ART

Conventionally, there have been known a wireless communication system comprising a plurality of base stations in order to enlarge its service area. In the conventional wireless communication system, a mobile wireless station is operative to transmit to any one of base stations on the same transmission frequency, so that the mobile wireless station can originate a call to one of the base stations regardless of which service area the mobile wireless station is placed in (for example, patent document 1).

### Patent Document 1: Patent Laid-Open Publication No. 2000-13844

### DISCLOSURE OF THE INVENTION

### Problems to be Solved

Although a mobile wireless station can initiate a call to one of base stations regardless of which service area the mobile wireless station is placed in, such a conventional wireless communication system, however, encounters a drawback that the mobile wireless station cannot automatically switch to the other base station when the mobile wireless station is moved away from the base station currently in process of communication and thus aggravated in a receiving status although there may be placed another base station in the vicinity thereof. This means that, in such a case, the mobile wireless station is required to disconnect from the base station currently in process of communication and newly establish a connection with the other base station which is placed in the vicinity thereof and enables the mobile wireless station to be recovered in a receiving status.

The present invention is made with a view to overcoming the previously mentioned drawback, and it is an object of the present invention to provide a wireless communication system, which enables the mobile wireless station to automatically switch to the other base station when the mobile wireless station is aggravated in a communication status with the base station currently in process of communication, to ensure that the communication is maintained in an excellent status although the mobile wireless station may be moved around within service areas.

### Means of Solving the Problems

In accordance with the present invention, there is provided a wireless communication system, comprising: a plurality of mobile wireless station apparatuses; a plurality of base station control apparatuses; and a base station control apparatus connected with the plurality of base station apparatuses and operative to output audio signals from the mobile wireless station apparatuses to all of the plurality of base station apparatuses, the plurality of base station apparatuses operative to communicate with the mobile wireless station apparatuses on respective transmission frequencies and receiving frequencies different from one another, and in which the base station apparatus is operative to transmit to the mobile wireless station apparatus a data signal indicative of “transmission permitted” when the base station apparatus can receive a transmission signal from the mobile wireless station apparatus and a data signal indicative of “transmission inhibited” when the base station apparatus cannot receive a transmission signal from the mobile wireless station apparatus, the mobile wireless station apparatus is operative to monitor a receiving status of radio wave, and switch to a base station apparatus which is better in the receiving status than the base station apparatus currently communicating and transmitting the data signal indicative of “transmission permitted”, when the receiving status becomes worse than a predetermined receiving status.

The wireless communication system according to the present invention thus constructed enables the mobile wireless station apparatus to automatically switch to the other base station apparatus which is better in the receiving status than the base station apparatus currently communicating and capable of receiving a transmission signal from the mobile wireless station, when the receiving status becomes worse than a predetermined receiving status.

Further, in the aforementioned wireless communication system, said base station apparatus may include received signal outputting means for demodulating a received radio wave into a received signal to be outputted therethrough, separating means for separating said received signal into an audio signal and a data signal, converting means for converting said data signal into data, synthesizing means for generating an instructional data signal and synthesizing said instructional data signal with said audio signal, transmitting means for modulating a signal synthesized and outputted by said synthesizing means into a radio wave to be transmitted therethrough, and controlling means for transmitting a data signal indicative of “transmission permitted” when capable of receiving a transmission signal from said mobile wireless station apparatus and a data signal indicative of “transmission inhibited” when not capable of receiving a transmission signal from said mobile wireless station apparatus, said mobile wireless station apparatus may include received signal outputting means for demodulating a received radio wave into a received signal to be outputted therethrough, electric field intensity detecting means for detecting an electric field intensity of said received signal, separating means for separating said received signal into an audio signal and a data signal, converting means for converting said data signal into data, audio signal inputting means for inputting said audio signal, synthesizing means for synthesizing a data signal generated based on said data with audio signal inputted by said audio signal inputting means, transmitting means for modulating a signal synthesized by said synthesizing means into a radio wave to be transmitted therethrough, and controlling means for monitoring an electric field intensity of said received signal while communicating with said base station apparatus, and detecting an electric field intensity of said received signal from each of base station apparatuses other than said base station apparatus currently communicating, receiving radio waves from said base station apparatuses in decreasing order of an electric field intensity of said received signal, and switch to a base station apparatus which is transmitting said data signal indicative of “transmission permitted”, when said receiving status becomes worse than a predetermined receiving status.

The wireless communication system according to the present invention thus constructed enables the mobile wireless station apparatus to search a base station which is strong in the electric field intensity of the received radio wave and capable of receiving a transmission signal, and automatically switch to the base station apparatus.

### EFFECT OF THE INVENTION

The wireless communication system according to the present invention ensures that the communication is maintained in an excellent status although the mobile wireless station apparatus may be moved around within service areas, resulting from the fact that the mobile wireless station apparatus is automatically switch to the other base station apparatus which is better in the receiving status than the base station apparatus currently communicating and capable of receiving a transmission signal from the mobile wireless station apparatus, when the receiving status becomes worse than a predetermined receiving status.

### BRIEF DESCRIPTION OF THE DRAWINGS

The features and advantages of a wireless communication system according to the present invention will be more clearly understood from the following description taken in conjunction with the accompanying drawings:

FIG. 1 is a block diagram showing a base station and a mobile wireless station forming part of a preferred embodiment of a wireless communication system according to the present invention;

FIG. 2 is a block diagram showing a preferred embodiment of a base station control apparatus according to the present invention;

FIG. 3 is diagram explaining an operation of the preferred embodiment of the wireless communication system according to the present invention;

FIG. 4 is a diagram explaining an operation of the preferred embodiment of the wireless communication system according to the present invention when the mobile wireless station transmits a signal;

FIG. 5 is a diagram explaining a state of the preferred embodiment of the wireless communication system according to the present invention when the mobile wireless station is moved;

FIG. 6 is a diagram explaining an operation of the preferred embodiment of the wireless communication system according to the present invention when the base station is switched.

### EXPLANATION OF THE REFERENCE NUMERALS

1, 1a to 1c base station
101 receiving antenna
102 receiving circuit
103 audio filtering circuit
104 DTMF filtering circuit
105 DTMF converting circuit
106 DTMF generating circuit
107 adding unit
108 transmitting circuit
109 transmitting antenna
110 CPU
2, 2a, 2b mobile wireless station
201 receiving antenna
202 receiving circuit
203 audio filtering circuit
204 DTMF filtering circuit
205 DTMF converting circuit
206 DTMF generating circuit
207 adding unit
208 transmitting circuit
209 transmitting antenna
210 CPU
3 base station control apparatus
301 CPU
302 audio matrix switcher

### DESCRIPTION OF THE PREFERRED EMBODIMENTS

A preferred embodiment of the wireless communication system according to the present invention will be described hereinafter in accordance with the accompanying drawings.

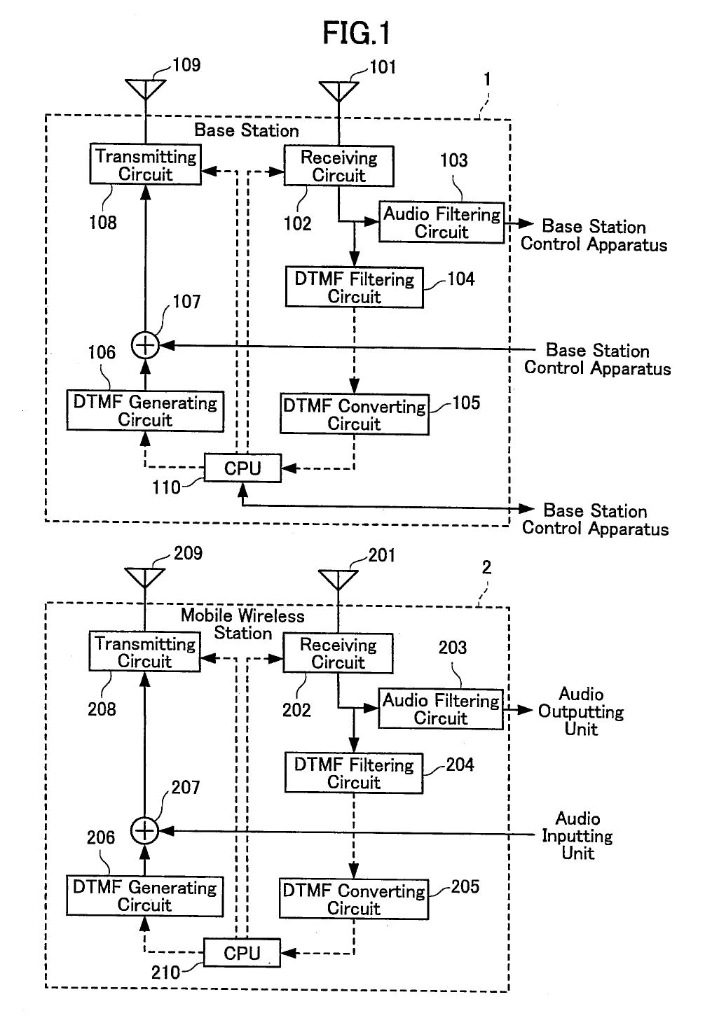

FIG. 1 is a block diagram showing a base station and a mobile wireless station forming part of a preferred embodiment of the wireless communication system according to the present invention.

As shown in FIG. 1, the base station 1 comprises a receiving antenna 101 for receiving a radio wave from a mobile wireless station 2, a receiving circuit 102 for demodulating the radio wave received by the receiving antenna 101 into a received signal to be outputted therethrough, an audio filtering circuit 103 for filtering and extracting from the received signal outputted from the receiving circuit 102 an audio signal to be outputted to a base station control apparatus, which will be described later, a DTMF filtering circuit 104 for filtering and extracting from the received signal outputted from the receiving circuit 102 a DTMF (Dual Tone Multi-Frequency) signal, a DTMF converting circuit 105 for converting the DTMF signal extracted by the DTMF filtering circuit 104 into data, a DTMF generating circuit 106 for generating a DTMF signal based on inputted data, an adding unit 107 for adding the audio signal inputted from the base station control apparatus and the DTMF signal generated by the DTMF generating circuit 106, a transmitting circuit 108 for modulating a signal outputted from the adding unit 107 into a transmitting radio wave to be outputted therethrough, a transmitting antenna 109 for transmitting the transmitting radio wave outputted from the transmitting circuit 108, and a CPU (Central Processing Unit) 110 for controlling each of the above mentioned circuits to have the above mentioned circuits operate as a base station based on a control signal from the base station control apparatus.

The mobile wireless station 2 comprises a receiving antenna 201 for receiving a radio wave from the base station, a receiving circuit 202 for demodulating the radio wave received by the receiving antenna 201 into a received signal to be outputted therethrough, an audio filtering circuit 203 for filtering and extracting from the received signal outputted from the receiving circuit 202 an audio signal to be outputted to an audio outputting unit, not shown, such as, for example, an ear phone, a DTMF filtering circuit 204 for filtering and extracting from the received signal outputted from the receiving circuit 202 a DTMF signal, a DTMF converting circuit 205 for converting the DTMF signal extracted by the DTMF filtering circuit 204 into data, a DTMF generating circuit 206 for generating a DTMF signal based on inputted data, an adding unit 207 for adding the audio signal inputted from an audio inputting unit, not shown, such as, for example, microphone, and the DTMF signal generated by the DTMF generating circuit 206, a transmitting circuit 208 for modulating a signal outputted from the adding unit 207 into a transmitting radio wave to be outputted therethrough, a transmitting antenna 209 for transmitting the transmitting radio wave outputted from the transmitting circuit 208, and a CPU (Central Processing Unit) 210 for controlling each of the above mentioned circuits to have the above mentioned circuits operate as a mobile wireless station 2.

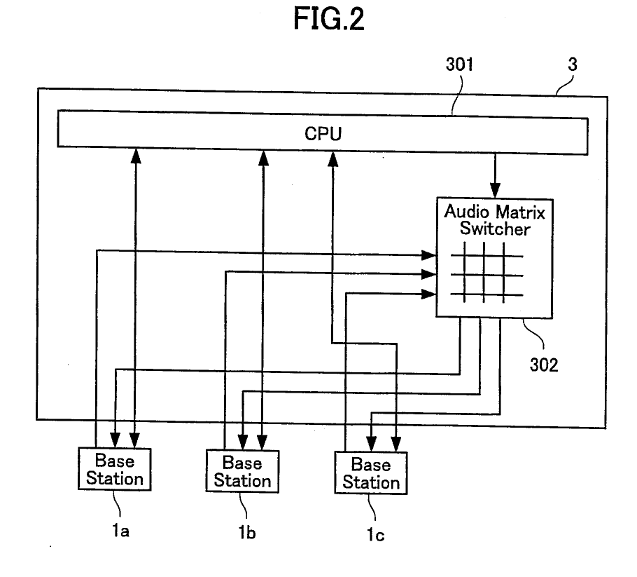

FIG. 2 is a block diagram showing a base station control apparatus 3 for controlling a plurality of base stations to enlarge a service area.

As shown in FIG. 2, the base station control apparatus 3 comprises a CPU 301 for transmitting a control signal to and thus controlling each of the base stations 1a to 1c to have an audio signal from the mobile wireless station 2 transmitted to each of the base stations 1a to 1c, and an audio matrix switcher 302 for inputting audio signals from each of the base stations 1a to 1c and mixing and switching the audio signals to be outputted to each of the base stations 1a to 1c under the control of the CPU 301.

In the wireless communication system thus constructed, each of the base stations 1a to 1c is assigned to a single transmission frequency and a single receiving frequency respectively to be used for transmitting radio waves to and receiving radio waves from the mobile wireless station 2, and the base stations 1a to 1c are different from one another in the transmitting and receiving frequencies. Each of the base stations 1a to 1c is operative to transmit radio waves at predetermined time intervals even though the no audio signal may be transmitted from the mobile wireless station 2.

In the present embodiment, it is assumed hereinlater that the base station 1a is assigned to, for example, a frequency f11 as the transmission frequency and a frequency f12 as the receiving frequency, the base station 1b is assigned to, for example, a frequency f21 as the transmission frequency and a frequency f22 as the receiving frequency, and the base station 1c is assigned to, for example, a frequency f31 as the transmission frequency and a frequency f32 as the receiving frequency.

The mobile wireless station 2 is designed to have stored therein the transmission frequency and the receiving frequency of each of the base stations 1a to 1e, and is operative to receive radio waves one after another transmitted on the transmission frequency of each of the base stations 1a to 1c (i.e., each of the transmission frequencies f11, f21, and f31 used for transmitting radio waves from the base stations 1a to 1c to the mobile wireless station 2), compare electric field intensities of the radio waves respectively received from the base stations 1a to 1c, store therein ranking of the electric field intensities of the radio waves respectively received from the base stations 1a to 1c, and control the receiving circuit 202 to receive the radio wave from the base station which is the strongest in the electric field intensity of the radio wave among the base stations 1a to 1c. Further upon transmitting a transmission request, the mobile wireless station 2 is designed to transmit the transmission request on the receiving frequency of the base station which is the strongest in the electric field intensity among the base stations 1a to 1c, (i.e., the transmission frequency used for transmitting radio waves from the mobile wireless station 2 to the base station 1).

In the concrete, the CPU 110 forming part of each of the base stations 1a to 1c is operative to control the transmitting circuit 108 to transmit a radio wave at predetermined time intervals for a predetermined time period on the transmission frequency f11, f21, or f31.

The CPU 210 forming part of the mobile wireless station 2 is operative to control the receiving circuit 202 to receive the radio wave transmitted from each of the base stations 1a to 1c at the predetermined time intervals for the predetermined time period on the transmission frequency f11, f21, or f31, detect electric field intensity of the radio wave, store in a RAM (Random Access Memory) included therein ranking of the electric field intensities of the radio waves respectively received from the base stations 1a to 1c, and control the receiving circuit 202 to receive the radio wave from the base station which is the strongest in the electric field intensity among the base stations 1a to 1c.

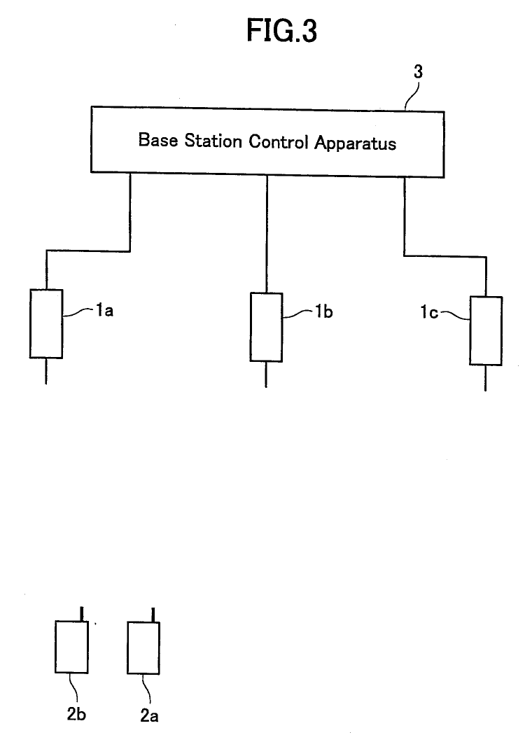

In the case of, for example, a mobile wireless station 2a placed in a position as shown in FIG. 3, the base station 1a is closest in distance and strongest in electric field intensity among the base stations 1a, 1b, and 1c, followed by the base station 1b and the base station 1c in order of increasing distance and decreasing electric field intensity.

Therefore, the CPU 210 forming part of the mobile wireless station 2a is operated to control the receiving circuit 202 to receive the radio wave on the frequency f11 of the base station 1a until the ranking of the electric field intensities of the radio waves received from the base stations 1a to 1c is updated. Likewise, in the case of a mobile wireless station 2b, the same procedure is carried out.

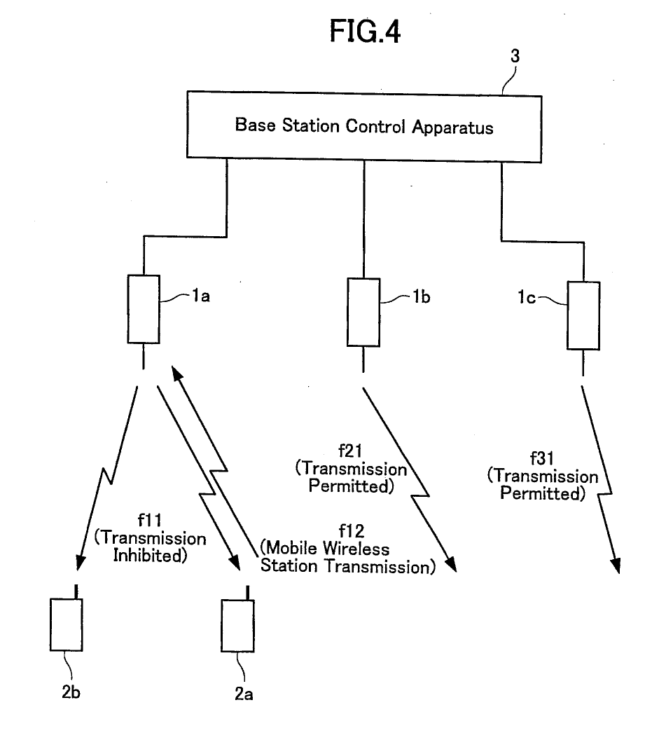

When the CPU 210 forming part of the mobile wireless station 2a detects that a transmission button, not shown, is pressed under the condition that the mobile wireless station 21 remains placed in the position as shown in FIG. 3, the CPU 210 forming part of the mobile wireless station 2s is operated to refer to the stored ranking of the electric field intensities of the radio waves respectively received from the base stations 1a to 1c, and read the transmission frequency f12 used for transmitting radio waves from the mobile wireless station 2a to the base station 1a and twin to the frequency F11 of the base station 1c which is strongest in the electric field intensity among the base stations 1a to 1c, have the DTMF generating circuit 206 generate a DTMF signal indicative of “mobile wireless station transmission”, have the adding unit 207 add the audio signal outputted from the audio inputting unit to the DTMF signal, and have the transmitting circuit 208 transmit a signal thus added on the frequency f12, as clearly seen from FIG. 4.

In the he base station 1a, it is detect that the receiving circuit 102 has received a radio wave from the mobile wireless station 2a, and a received signal demodulated from the received radio wave is outputted to the audio filtering circuit 103 and the DTMF filtering circuit 104.

The audio filtering circuit 103 is operated to filter and extract from the received signal outputted from the receiving circuit 102 an audio signal to be outputted to the base station control apparatus 3. The DTMF filtering circuit 104 is operated to filter and extract from the received signal outputted from the receiving circuit 102 a DTMF signal to be outputted to the DTMF converting circuit 105.

The DTMF converting circuit 105 is operated to detect the DTMF signal from among signals inputted thereto, and convert the detected DTMF signal into data to be reported to the CPU 110.

The CPU 110 is operated to judge the data reported from the DTMF converting circuit 105, and transmit a transmission request to the base station control apparatus 3 when it is judged that the reported data is indicative of “mobile wireless station transmission”.

Upon receiving the transmission request from the base station 1a, the CPU 301 forming part of the base station control apparatus 3 is operated to judge whether or not the transmission request is acceptable, transmit a signal indicative of “transmission permitted” to the base station 1a and a signal indicative of “transmission start” to the base stations 1b and 1c, and have the audio matrix switcher 302 connect the audio signals inputted from the base station 1a with audio signal outputs of all of the base stations 1a to 1c when it is judged that the transmission request is acceptable.

Upon receiving the data signal indicative of “transmission permitted”, the CPU 110 forming part of the base station 1a is operated to have the DTMF generating circuit 106 generate a DTMF signal indicative of “transmission inhibited”, have the adding unit 107 add the DTMF signal to the audio signal outputted from the base station control apparatus 3, and have the transmitting circuit 108 transmit radio waves generated based on a signal outputted from the adding unit 107 on the transmission frequency 11 of the base station 1a.

When the base station control apparatus 3 starts a transmitting operation, the CPU 110 forming part of each of the base stations 1b and 1c is operated to have the DTMF generating circuit 106 generate a DTMF signal indicative of “transmission permitted”, have the adding unit 107 add the DTMF signal to the audio signal from the base station 1a, outputted from the base station control apparatus 3, and have the transmitting circuit 108 start transmitting radio waves generated based on a signal outputted from the adding unit 107 on the transmission frequency f21 or f31.

The receiving circuit 202 forming part of the mobile wireless station 2a is operated to detect that the radio wave is received from the base station 1a, and output a received signal demodulated from the received radio wave to the audio filtering circuit 203 and the DTMF filtering circuit 204.

The audio filtering circuit 203 is operated to filter and extract from the received signal an audio signal to be outputted to the audio outputting unit. The DTMF filtering circuit 204 is operated to filter and extract from the received signal a DTMF signal to be outputted to the DTMF converting circuit 205.

The DTMF converting circuit 205 is operated to detect the DTMF signal from among signals inputted thereto, and convert the detected DTMF signal into data to be reported to the CPU 210.

The CPU 210 is operated to judge the data reported from the DTMF converting circuit 205, judge that the previously transmitted signal indicative of “mobile wireless station transmission” has been accepted when it is judged that the reported data is indicative of “transmission inhibited”, and continue the transmitting operation.

Further, the receiving circuit 202 forming part of the mobile wireless station 2b is operated to detect that the radio wave is received from the base station 1b, and output a received signal demodulated from the received radio wave to the audio filtering circuit 203 and the DTMF filtering circuit 204.

The audio filtering circuit 203 is operated to filter and extract from the received signal an audio signal to be outputted to the audio outputting unit. The DTMF filtering circuit 204 is operated to filter and extract from the received signal a DTMF signal to be outputted to the DTMF converting circuit 205.

The DTMF converting circuit 205 is operated to detect the DTMF signal from among signals inputted thereto, and convert the detected DTMF signal into data to be reported to the CPU 210.

The CPU 210 is operated to judge the data reported from the DTMF converting circuit 205, and transmit no signal indicative of “mobile wireless station transmission” even though it may be detected that the transmission button is pressed when it is judged that the reported data is indicative of “transmission inhibited”. This construction enables to prevent a plurality of mobile wireless stations from connecting with the same base station at the same time.

Further, in the mobile wireless station 2 which has received radio waves from the base stations 1b and 1c, the DTMF signal extracted from each of the received radio waves is indicative of “transmission permitted”, and the CPU 210 is operated to transmit a signal indicative of “mobile wireless station transmission” when it is detected that the transmission button is pressed.

The CPU 110 forming part of the base station 1 which has received the signal indicative of “mobile wireless station transmission” thus transmitted is operated to transmit a transmission request to the base station control apparatus 3 in the same manner as that of the base station 1a, which has described earlier.

The CPU 301 forming part of the base station control apparatus 3 which has received the transmission request thus transmitted is operated to transmit a signal indicative of “transmission permitted” to the base station 1 as well as set the audio matrix switcher 302 to have the audio matrix switcher 302 mix the audio signals inputted from the base station 1a with audio signals inputted from the base station 1 which has transmitted the transmission request, to be connected with outputs of all of the base stations 1a to 1c when it is judged that the transmission request is acceptable.

The CPU 110 forming part of the base station 1 which has received the signal indicative of “transmission permitted” from the base station control apparatus 3 is operated to synthesize the DTMF signal indicative of “transmission inhibited” with the audio signals and transmit a signal thus synthesized therethrough.

In the above-mentioned manner, a plurality of mobile wireless stations are enabled to make calls to one another through different base stations at the same time.

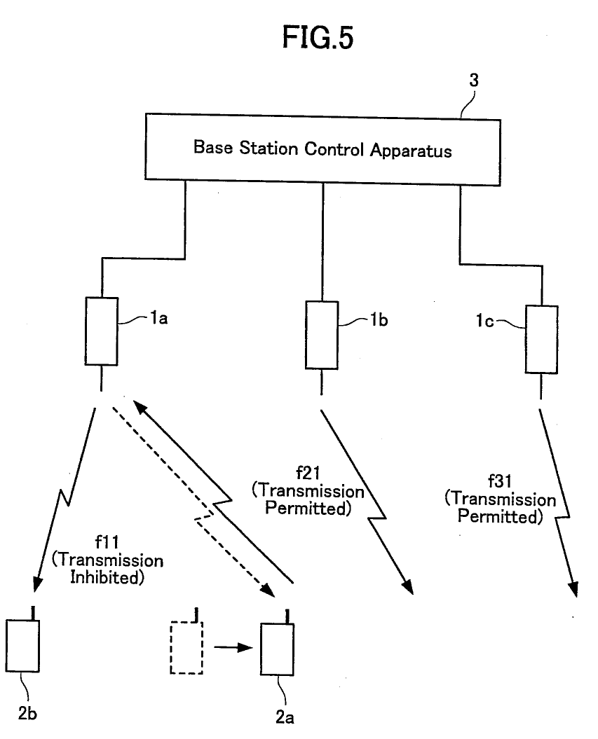

Further, the CPU 210 forming part of the mobile wireless station 2a is operated to receive a report of the electric field intensity of the received radio wave from the receiving circuit 202, judge that the distance from the base station 1 is increased as shown in FIG. 5 when the electric field intensity of the received radio wave becomes lower than a predetermined value, and control the receiving circuit 202 to have the receiving circuit 202 receive radio waves on the transmission frequencies f21 and f31 of the base stations 1b and 1c other than the base station 1a currently communicating, and detect the electric field intensity of each of the received radio waves.

The CPU 210 is then operated to control the receiving circuit 202 to have the receiving circuit 202 receive the radio wave from the base station which is strongest in the electric field intensity of the received radio wave from among the base stations, i.e., the radio wave on the transmission frequency f21 of the base station 1b in the case shown in FIG. 5, and judge whether or not the data reported by the DTMF converting circuit 205 based on the DTMF signal of the radio wave received from the base station 1b is indicative of “transmission permitted”.

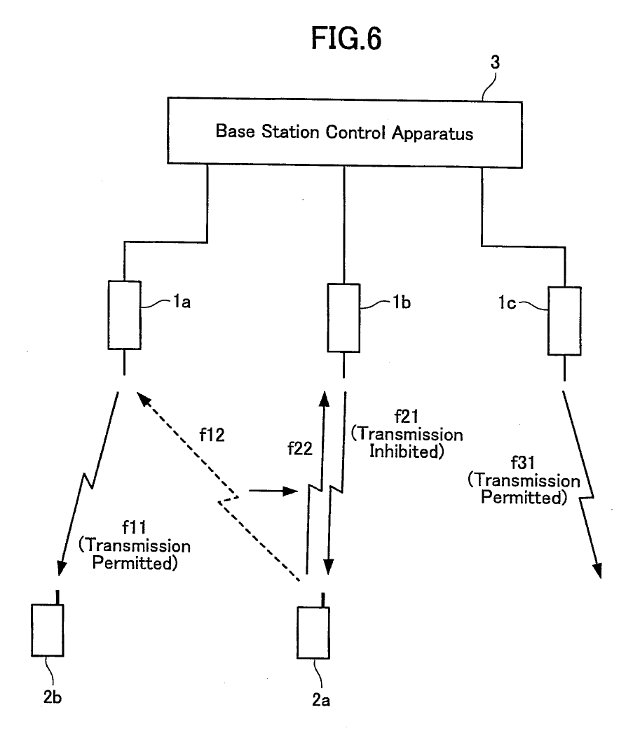

When it is judged that the data of the DTMF signal is indicative of “transmission permitted”, the CPU 210 is operated to control the transmitting circuit 208 to stop transmitting a radio wave to the base station 1a, as shown in FIG. 6, have the DTMF generating circuit 206 generate a DTMF signal indicative of “mobile wireless station transmission”, have the adding unit 207 add the audio signal outputted from the audio inputting unit to the DTMF signal, and have the transmitting circuit 208 transmit a signal thus added on the frequency f22 of the base station 1b.

Upon receiving the data signal indicative of “mobile wireless station transmission”, the CPU 110 forming part of the base station 1b is operated to transmit a transmission request to the base station control apparatus 3 in the same manner as that of the base station 1a, which has described earlier.

The CPU 301 forming part of the base station control apparatus 3 which has received the transmission request thus transmitted is operated to transmit a signal indicative of “transmission permitted” to the base station 1b as well as set the audio matrix switcher 302 to have the audio matrix switcher 302 mix the audio signals inputted from the base station 1b with audio signals currently being transmitted, if any, to be connected with outputs of the base stations 1a to 1c when it is judged that the transmission request is acceptable.

The CPU 110 forming part of the base station 1b which has received the signal indicative of “transmission permitted” from the base station control apparatus 3 is operated to synthesize the DTMF signal indicative of “transmission inhibited” with the audio signals and transmit a signal thus synthesized therethrough.

Upon detecting that the radio wave cannot be received by the receiving circuit 102, the CPU 110 forming part of the base station 1a, on the other hand, is operated to, transmit a data signal indicative of “transmission completed” to the base station control apparatus 3 and synthesize a DTMF signal indicative of “transmission permitted” with the audio signals and transmit a signal thus synthesized therethrough.

Upon receiving the data signal indicative of “transmission completed”, the CPU 301 forming part of the base station control apparatus 3 is operated to judge whether or not there is any other base station which is currently communicating, and set the audio matrix switcher 302 to have the audio matrix switcher 302 output no audio signal, and transmit a data signal indicative of “transmission completed” to all of the base stations 1a to 1c when it is judged that there is no other base station which is currently communicating.

Each of the base stations 1a to 1c which have received the data signal indicative of “transmission completed” is operated to have the transmission circuit 108 stop transmitting radio waves, but continue transmitting radio waves at predetermined time intervals for a predetermined time period.

When it is judged that there is any other base station which is currently communicating, the CPU 301 is operated to set the audio matrix switcher 302 not to have the audio matrix switcher 302 output any audio signal inputted from the base station 1a which has transmitted the data signal indicative of “transmission completed”.

When it is detected that the data of the DTMF signal from the base station 1b which is the strongest in electric field intensity of the radio wave is indicative of “transmission inhibited”, the CPU 210 forming part of the mobile wireless station 2a is operated to judge whether or not the data of the DTMF signal is indicative of “transmission permitted” for each of the base stations in order of decreasing electric field intensity. The CPU 210 forming part of the mobile wireless station 2a is operated to switch from the base station 1a to a base station in the same manner as the above mentioned case that data of the DTMF signal from the base station 1b is indicative of “transmission permitted” when it is judged that the data of the DTMF signal transmitted from the base station is indicative of “transmission permitted”. The CPU 210 forming part of the mobile wireless station 2a, on the other hand, is operated to continue communicating with the base station 1a when it is judged that there is found no base station which transmits the DTMF signal having data indicative of “transmission permitted”.

From the foregoing description, it is to be understood that, in the present embodiment, communication between the mobile wireless station 2 and the base station can be maintained in an excellent status although the mobile wireless station 2 may be moved in a service area, resulting from the fact that the mobile wireless station 2 in process of communication with the base station 1 is operative to monitor an electric field intensity of the radio wave from the base station 1, judge whether or not the data of the DTMF signal of the radio wave from a base station which is the strongest in the electric field intensity of the radio wave among a plurality of base stations other than the base station 1 is indicative of “transmission permitted” when the electric field intensity of the radio wave received from the base station 1 becomes lower than a predetermined value, and switch to the base station when the data is indicative of “transmission permitted”.

The present embodiment can reduce noises caused by the switching operation, resulting from the fact that the mobile wireless station 2 is firstly operative to search a base station which is strong in the electric field intensity of the received radio wave and transmits a DTMF signal having data indicative of “transmission permitted”, and then switch from the current base station to the searched base station apparatus.

In addition, in the present embodiment, the mobile wireless station 2 may be provided with, for example, a mute circuit, so as to prevent audio signals received during the switching operation from being outputted to the audio outputting unit. Such a construction enables to further reduce the noises caused by the switching operation.

### INDUSTRIAL APPLICABILITY OF THE PRESENT INVENTION

As will be seen from the foregoing description, the wireless communication system according to the present invention has an effect that communication between the mobile wireless station and the base station can be maintained in an excellent status although the mobile wireless station may be moved in a service area, and is available as, for example, a wireless communication system having a plurality of base stations with an enlarged service area.

What is claimed is:

1. A wireless communication system, comprising:
a plurality of mobile wireless station apparatuses;
a plurality of base station apparatuses; and
a base station control apparatus connected with said plurality of base station apparatuses and operative to output audio signals from said mobile wireless station apparatuses to all of said plurality of base station apparatuses,
said plurality of base station apparatuses operative to communicate with said mobile wireless station apparatuses on respective transmission frequencies and receiving frequencies different from one another, and in which
said base station apparatus is operative to transmit to said mobile wireless station apparatus a data signal indicative of “transmission permitted” when said base station apparatus can receive a transmission signal from said mobile wireless station apparatus and a data signal indicative of “transmission inhibited” when said base station apparatus cannot receive a transmission signal from said mobile wireless station apparatus,
said mobile wireless station apparatus is operative to monitor a receiving status of radio wave, and switch to a base station apparatus which is better in said receiving status than said base station apparatus currently communicating and transmitting said data signal indicative of “transmission permitted”, when said receiving status becomes worse than a predetermined receiving status.

2. A wireless communication system as set forth in claim 1, in which
said base station apparatus includes received signal outputting means for demodulating a received radio wave into a received signal to be outputted therethrough,
separating means for separating said received signal into an audio signal and a data signal,
converting means for converting said data signal into data,
synthesizing means for generating an instructional data signal and synthesizing said instructional data signal with said audio signal,
transmitting means for modulating a signal synthesized and outputted by said synthesizing means into a radio wave to be transmitted therethrough, and
controlling means for transmitting a data signal indicative of “transmission permitted” when capable of receiving a transmission signal from said mobile wireless station apparatus and a data signal indicative of “transmission inhibited” when not capable of receiving a transmission signal from said mobile wireless station apparatus,
said mobile wireless station apparatus includes received signal outputting means for demodulating a received radio wave into a received signal to be outputted therethrough,
electric field intensity detecting means for detecting an electric field intensity of said received signal,
separating means for separating said received signal into an audio signal and a data signal,
converting means for converting said data signal into data,
audio signal inputting means for inputting said audio signal,
synthesizing means for synthesizing a data signal generated based on said data with audio signal inputted by said audio signal inputting means,
transmitting means for modulating a signal synthesized by said synthesizing means into a radio wave to be transmitted therethrough, and
controlling means for monitoring an electric field intensity of said received signal while communicating with said base station apparatus, and detecting an electric field intensity of said received signal from each of base station apparatuses other than said base station apparatus currently communicating, receiving radio waves from said base station apparatuses in decreasing order of an electric field intensity of said received signal, and switch to a base station apparatus which is transmitting said data signal indicative of “transmission permitted”, when said receiving status becomes worse than a predetermined receiving status.
